(19) United States
(12) Patent Application Publication
(10) Pub. No.: US 2024/0339944 A1
(43) Pub. Date: Oct. 10, 2024

(54) POWER PRODUCTION OPTIMIZATION FOR A FLUID TURBINE

(71) Applicant: Vincent Loccisano, Wellesley, MA (US)

(72) Inventor: Vincent Loccisano, Wellesley, MA (US)

(21) Appl. No.: 18/629,452

(22) Filed: Apr. 8, 2024

Related U.S. Application Data
(60) Provisional application No. 63/495,090, filed on Apr. 8, 2023.

(51) Int. Cl. H02P 9/02; H02K 7/18

(52) U.S. Cl. CPC H02P 9/02; H02K 7/183

(57) ABSTRACT

A shrouded turbine provides improved power-extraction from a fluid stream, increasing Annual Energy Production (AEP) without additional hardware. Because grid current varies significantly from maximum current for which a system of electrical components and the grid connection are designed, and since electrical components are designed for a condition in which voltage is lower than nominal and cos-phi is lower than 1.0, a current reserve is provided and is defined by the following equation:

Iₘₐₓ−I_{actual}

By continuously calculating the current-capacity reserve and translating this to an equivalent power, a potential power reserve is provided. Adjusting the power intake from the rotor to a higher power set-point may be accomplished without exceeding maximum current to the grid for which electrical components are designed.

### TECHNICAL FIELD

The present disclosure relates to turbines for power generation and, in particular, to fluid turbines with a rotor; a permanent-magnet rotational electric machine (e.g., a three-phase permanent-magnet motor and generator, AC synchronous motor and generator); and an electoral system to convert mechanical energy in a fluid stream to electrical energy at grid-connection terminals. The present disclosure also relates to a method of increasing annual energy production without increasing a turbine's maximum power-production rating.

### BACKGROUND

Conventional horizontal-axis fluid turbines used for power generation are known to have, e.g., two to five open blades, arranged like a propeller. The blades are typically mounted to a horizontal shaft attached to a gear box, or by direct drive to a power generator. Kinetic energy in the fluid stream is converted to mechanical energy by the rotor and then to electrical energy by the generator. A controller modifies the electrical energy prior to delivery to the grid. Input of energy to the system is determined by the characteristics of the components and by the fluid-dynamic properties of the system.

Electrical energy from the generator is delivered to an electrical grid at grid-connection terminals. The power delivered to the grid is determined by grid-connection interface parameters such as grid voltage, grid current and grid cos phi. The controller is designed to transfer power produced by the generator to the grid within specified limits.

Diffuser-augmented or duct-augmented fluid turbines are known to increase the amount of energy that a given turbine rotor can extract from a fluid stream. In a diffuser-augmented, ducted turbine, the upstream flow-capture area of the fluid stream is larger than the area at the rotor plane due to flow-contraction at the duct. The contracted fluid stream accelerates at the rotor plane by the duct, and expands and decelerates in the diffuser portion of the duct after leaving the duct (downstream of the duct). The amount of energy that may be harvested from the fluid is proportional to the upstream flow-capture area, where the fluid stream starts in a non-contracted state. In a conventional diffuser-augmented turbine, the diffuser surrounds the rotor such that the diffuser guides incoming fluid before the fluid interacts with the rotor, enabling greater energy extraction at the rotor.

Annular airfoils used in ducted fluid turbines have an inlet or leading edge and an exit or trailing edge with the lift or suction side of the airfoils on the side proximal to the rotor. The fluid stream is divided into a low-pressure, high-velocity stream on the interior side of the airfoil, and a high-pressure, lower-velocity stream on the airfoil's exterior. The higher-pressure, lower-velocity stream is part of the free stream, with relatively higher momentum, and is referred to as bypass flow.

Vectors are used to represent a sine wave of current relative to a sine wave of voltage. In such a representation, a vector length represents the root mean square (RMS) value of current, and the direction of the vector represents the phase angle of the current relative to voltage. Load current multiplied by the system voltage, multiplied by cos phi, yields real load, or real power. Units of real power are watts, measured as kW, MW etc.

Reactive power is derived by multiplying the system voltage by the reactive current. The units of reactive power are measured in Volts-Amps-Reactive or kVAR, MVAR, etc.

Apparent power is derived by multiplying the system voltage by the apparent current. Units of apparent power are volt-amps or VA, kVA, MVA etc.

Power production to the grid is determined by the grid connection interface parameters such as grid voltage, grid current and grid cos phi (see FIG. 1). In some environments, the grid voltage is at a nominal 600V and varies by a nominal increase or decrease. In one example, a grid voltage of 600V may vary by an increase or decrease of approximately 10%. Cos phi in such environments usually ranges between 0.9 and 1. Grid cos phi is also referred to as the external set-point, and may typically be set by a local grid operator to a value between 0.9 and 1.0 by an external set-point.

### SUMMARY

Example fluid turbines include turbines with a rotor for extracting energy from a fluid stream engaged with a generator for converting mechanical energy to electrical energy, and a means of connection to a power grid.

Double-shrouded fluid turbines presented here may be a turbine shroud (e.g., a primary annular airfoil) having a rotor within it. A turbine shroud includes an inlet defining a leading edge and an outlet that defines a trailing edge. The rotor includes a hub engaged with a rotor blade. Fluid turbines may have an ejector shroud with an ejector-shroud inlet defining an ejector-shroud leading edge, and an outlet defining a trailing edge. In some embodiments, a turbine shroud and ejector shroud include faceted sides.

The turbine shroud can be coaxial with a central axis of the fluid turbine. The outlet of the turbine shroud can extend downstream of the ejector shroud inlet such that the turbine shroud and the ejector shroud can be in fluid communication with each other. Both the turbine shroud and the ejector shroud can define an inner, suction surface and an outer, pressure surface.

Example single-shrouded fluid turbines include a turbine shroud having a rotor within it. The turbine shroud includes an inlet defining a leading edge and an outlet defining a trailing edge. The rotor includes a hub and a rotor blade engaged with the hub.

Example fluid turbines include an annular airfoil, e.g., a turbine shroud, coupled to a rotor that is in communication with a generator/electrical-generation equipment. The annular airfoil can be in fluid communication with the rotor. The annular airfoil can provide a given percent volume of free-stream fluid to a rotor plane through an inlet area of the annular airfoil.

In example embodiments, the power output of a fluid turbine may be described by the following equation:

$$P = V \times I \times cos cos ρ hi$$

Where P=Power produced by the system, V=voltage, I=current and cos phi is the phase of the voltage and current.

A fluid turbine with a three-phase electrical system may be defined by the following equation:

$$P = V \times I \times cos cos ρ hi \times \sqrt{3}$$

Where P=Power produced by the system, V=voltage, I=current and cos phi is the phase difference between the voltage and current, and 43 represents a three-phase system.

In these example embodiments, the grid current may vary significantly compared to the maximum current. In some embodiments the grid current may vary between 20% and 30% of the maximum current for which the system of electrical components and grid connection are designed, during nominal power production at different grid conditions and cos phi set points.

Since the electrical components are designed for the conditions in which current is up to 30% higher than nominal, there are necessarily conditions in which a system is operating up to 30% lower than nominal, giving a current reserve defined by the following equation:

Iₘₐₓ−I_{actual}

By continuously calculating the capacity reserve and translating this to an equivalent power, a potential power reserve is provided. Adjusting the power intake from the rotor to a higher power set-point may be accomplished without exceeding the maximum current to the grid for which the electrical components are designed.

Fluid turbines are used to extract energy from fluids such as air (e.g., wind) or water. The aerodynamic principles of a wind turbine of the present invention apply also to hydrodynamic principles of a comparable water turbine.

### BRIEF DESCRIPTION OF THE DRAWINGS

FIG. 1 is a diagram depicting the cos phi of a fluid-turbine system;

FIG. 2 is graph depicting grid current at Un=600V, Cos phi=1 at nominal power production;

FIG. 3 is a graph depicting grid current at various grid conditions at nominal power production;

FIG. 4 is a graph depicting theoretical power-capacity reserve in various conditions;

FIG. 5 is a perspective view of an example shrouded turbine;

FIG. 6 is a perspective view of an example multiple-shrouded turbine.

### DESCRIPTION

A shrouded turbine provides improved power-extraction from a fluid stream, increasing Annual Energy Production (AEP) without additional hardware. It applies to example fluid turbines with rotors coupled with generators which are further connected to a power grid through a controller. Other applications include fluid turbines having at least one turbine shroud(s), e.g., a turbine shroud, an ejector shroud, or both. In some embodiments a turbine shroud and an ejector shroud include faceted segments.

Although the present embodiment may be employed to increase the AEP of an open-rotor turbine or a vertical-axis turbine, there are specific advantages to the application of the present embodiment with a shrouded turbine. A shrouded turbine may employ a smaller rotor than open-rotor turbines of similar power-production capacity. Increasing the set point on a turbine with a relatively smaller rotor results in relatively less stress and strain on mechanical components than on that of a relatively larger rotor.

A shrouded turbine of the present disclosure provides an improved fluid turbine for extracting power from a fluid stream. At least one substantially annular airfoil can be in fluid communication with a rotor. The term “rotor” can be used herein to refer to any assembly in which one or more blades or blade segments are attached to a shaft and able to rotate, enabling generation or extraction of power or energy from fluid flow rotating the blade(s) or blade segments. Example rotors may include a propeller-like rotor, a rotor/stator assembly, a multi-segment propeller-like rotor, or any type of rotor understood by one skilled in the art that may be associated with the ringed airfoil of the present disclosure. As used herein, the term “blade” includes all aspects of suitable blades, including those having multiple associated blade segments.

A turbine's leading edge is here considered the front of the turbine, and the trailing edge of a ringed airfoil may be considered the rear. A first component of the fluid turbine located closer to the front of the turbine is considered “upstream” of a second, rearward “downstream” component.

In an example embodiment, a fluid turbine has a rotor in combination with an annular airfoil (shroud). In some embodiments, the annular airfoil includes a substantially annular leading edge in fluid communication with the circumference of a rotor plane. In some embodiments, the annular leading edge may transition to a trailing edge with faceted segments; this is referred to as a hybrid polygonal airfoil. In some embodiments, a second annular airfoil may be in fluid communication with the trailing edge of the turbine shroud. The second airfoil is referred to as an ejector shroud and may be coaxial with the turbine shroud. In some embodiments, the ejector shroud may be configured as a faceted, annular airfoil. One skilled in the art understands that a faceted airfoil may have any number of facets, or may be a ringed airfoil. Asymmetrical configurations are within the scope of the present invention.

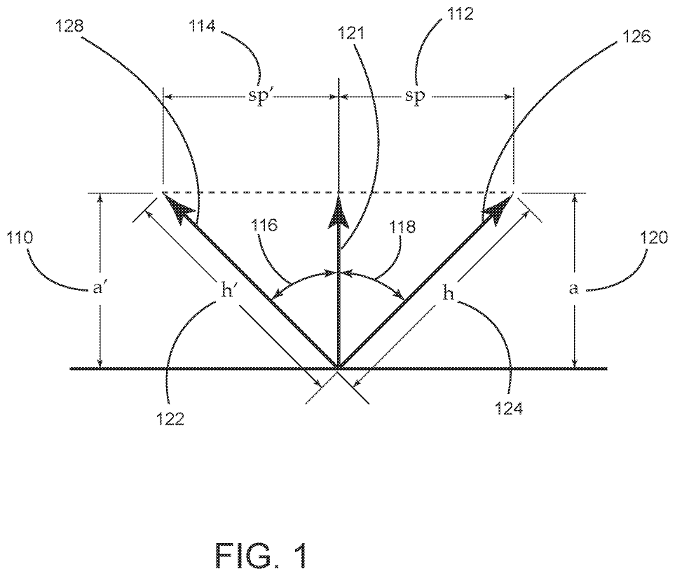

FIG. 1 shows a vector diagram depicting the active and reactive power as produced by an example fluid turbine. Apparent power represented by vector 126 has a magnitude represented by length h and a phase shift represented by angle 118. The cosine of angle 118 is a product of a/h, referenced by distance 120 divided by distance 124. The magnitude h, 124, and magnitude a, 120, and the cosine of angle 118 dictate the active-power set-point (sp) 121, otherwise referred to as the active power of the turbine. Similarly, apparent power can also be represented by vector 128, and has a magnitude represented by length h′ and a phase shift represented by the angle 116. The cosine of angle 116 is a product of a′ h′, referenced by distance 110 divided by distance 122. The magnitude h′, 122, and/or the magnitude h 124 is a product of the active power 121, and the cos phi, which is a variable set point applied by the local grid operator. The cos phi set point may be either leading 116, or lagging 118.

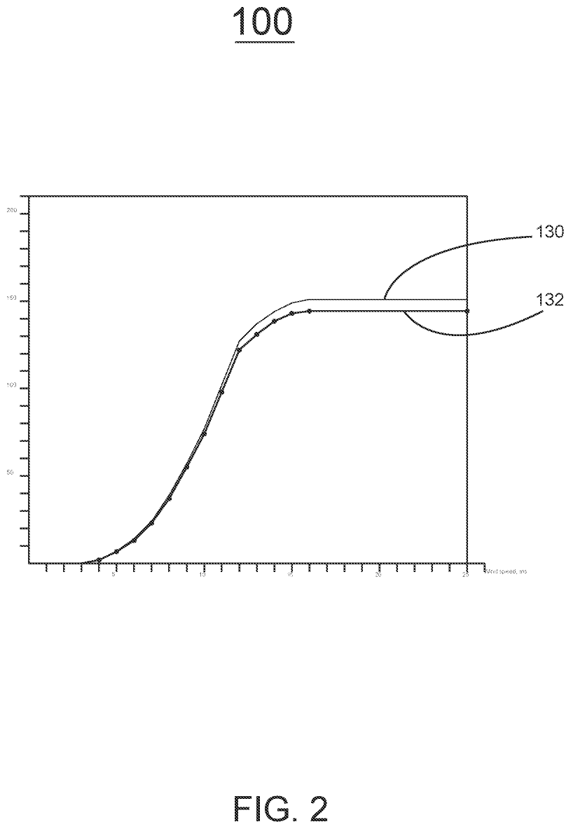

FIG. 2 shows a graph of energy production of an example 150 kW fluid turbine in normal flow conditions. Nominal power production is represented by curve 130. Power production when the grid current is at U_{N}=600V, U_{N} is the nominal voltage e.g. 600V, and Cos-phi=1 is represented by curve 132.

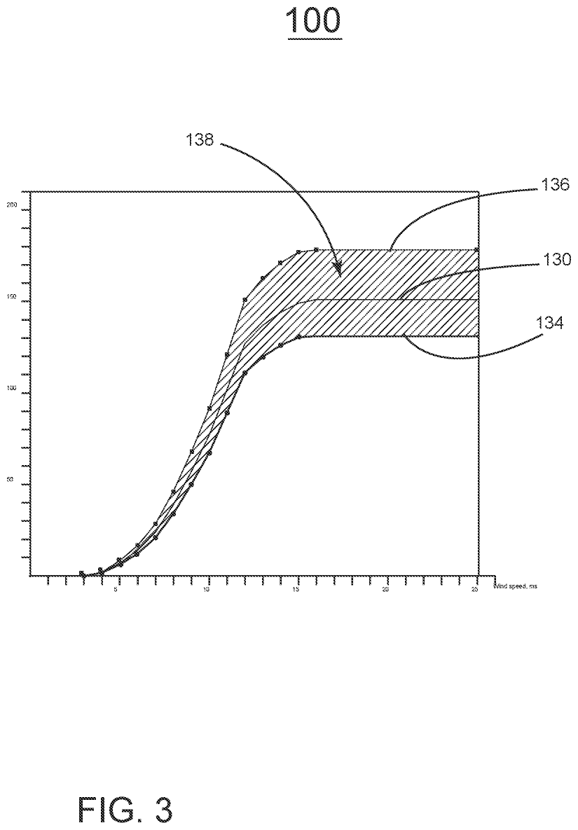

FIG. 3 shows a graph of energy production of an example 150 kW fluid turbine in optimal vs. less-than-optimal flow conditions. In optimal conditions, the example turbine, operating at nominal power and a grid voltage at 600V+10% and cos-phi=1, provides a current to the grid of 131A, represented by curve 134. The same 150 kW fluid turbine in less-than-optimal conditions, in which the grid operates at 600V-10% at a cos-phi at 0.9, provides a maximum current to the grid of 178A, represented by curve 136. Nominal power production is represented by curve 130. Typically, a fluid turbine is designed for the less-than-optimal condition, with electrical components and grid-connection related components designed to withstand the resultant heat and strain on the system. Given that the current can vary between approximately 131A, curve 134, and 178A, curve 136, during normal, nominal production of 150 kW at different grid conditions and varying cos-phi set-points, nominal production exists in the range represented by hashed area 138.

Specifically, an example embodiment of a fluid turbine may have a maximum power output of 150 kW or 150,000 watts, wherein the maximum power output of the turbine is represented by the following equation:

$$150000 = 600 \times I \times 1 \times \sqrt{3}$$

In the aforementioned example embodiment of a fluid turbine having a maximum power output of 150 kW or 150,000 watts wherein the grid is operating at 600V-10%, the maximum current provides a given number of Amps to the grid, defined by the following equation:

$$I = \frac{150 , 000}{600 \times 0.9 \times \sqrt{3} \times 0.9} = 178 A$$

In another example embodiment, the aforementioned fluid turbine having a maximum power output of 150 kW or 150,000 watts wherein the grid at 600V+10%, the maximum current provides a given number of Amps to the grid, defined by the following equation:

$$I = \frac{150 , 000}{600 \times 1.1 \times \sqrt{3} \times 1} = 131 A$$

In the former example case, the turbine operating at nominal power at a grid voltage operating at 600V−10% and cos phi is adjusted to 0.9, the resultant current will be approximately 178A, thus providing a maximum load to the electrical system.

In the latter example case, the turbine operating at nominal power at a grid voltage operating at 600V+10% and cos phi=1, the resultant current will be 131A, thus providing a lower-than-maximum load to the electrical system.

Using the same equation, we can conclude that it is possible to increase production to approximately 203 kW without exceeding the maximum load to the system, while providing a theoretical power-capacity reserve.

$$I = \frac{203 , 000}{600 \times 1.1 \times \sqrt{3} \times 1} = 178 A$$

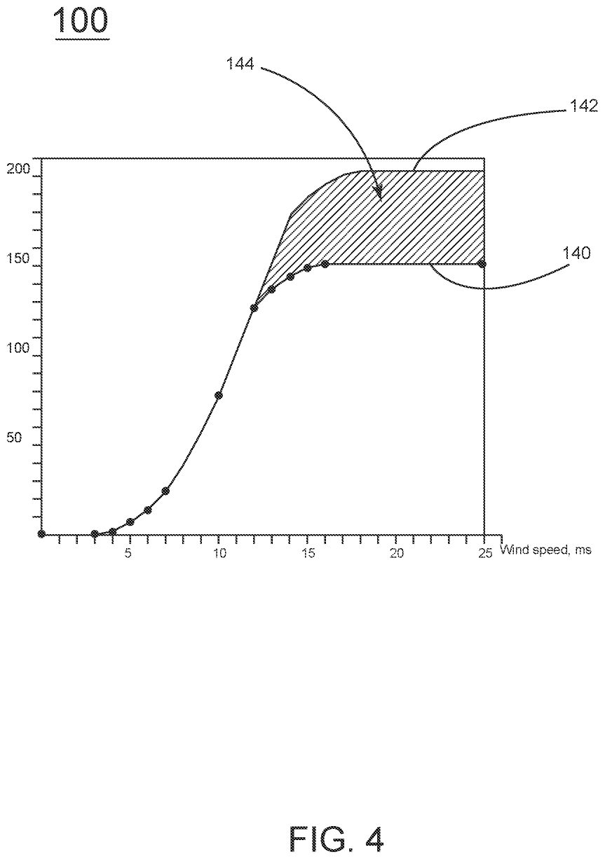

Given that the example turbine is designed for the less-than-optimal condition, in any case wherein the ambient temperature is below the maximum ambient temperature that the turbine is designed for, FIG. 4 shows that it remains possible to increase the production from 150 kW, represented by curve 140, up to approximately 203 kW (curve 142), thus providing a theoretical power capacity reserve represented by hashed area 144. The embodiment is a means and method of increasing the AEP without increasing the cost of producing the turbine.

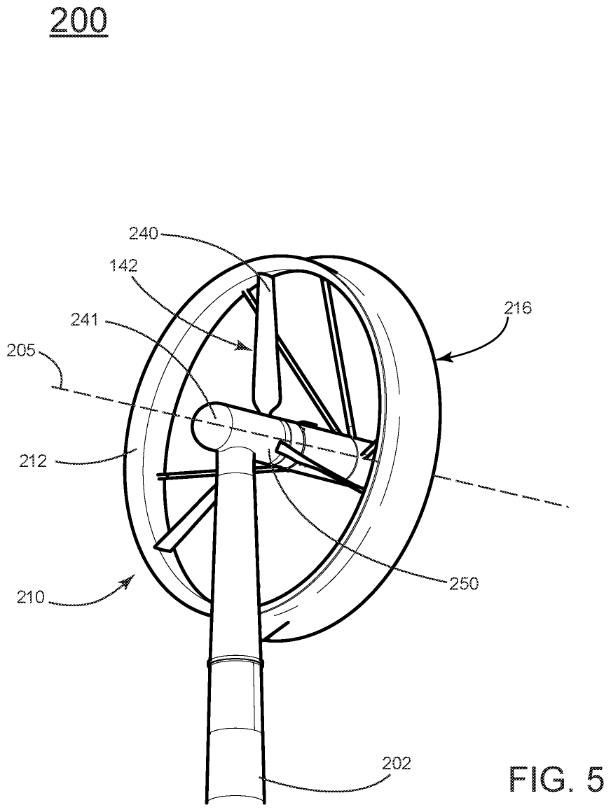

In FIG. 5, an example embodiment fluid turbine 200 comprises rotor blades 240 that are joined at a central hub 241 and rotate about a central axis 205. The hub is joined to a shaft that is coaxial with the hub and with the nacelle 250. An annular duct 210 is in fluid communication with the rotor 240. The annular duct 210, also referred to as a turbine shroud, comprises a leading-edge portion or inlet 212 that is substantially annular, providing a relatively narrow gap between the rotor blade 240 tips and the interior surface of the leading edge 212. The turbine shroud further comprises a trailing edge or exit 216 of the annular duct 210. The annular duct 210 is coaxial with the rotor 240, rotor hub 241 and nacelle 250 about the central axis 205. Struts 233 are engaged with the nacelle 250 at the distal end and with turbine shroud 210 at the proximal end. A tower structure 202 supports turbine 200.

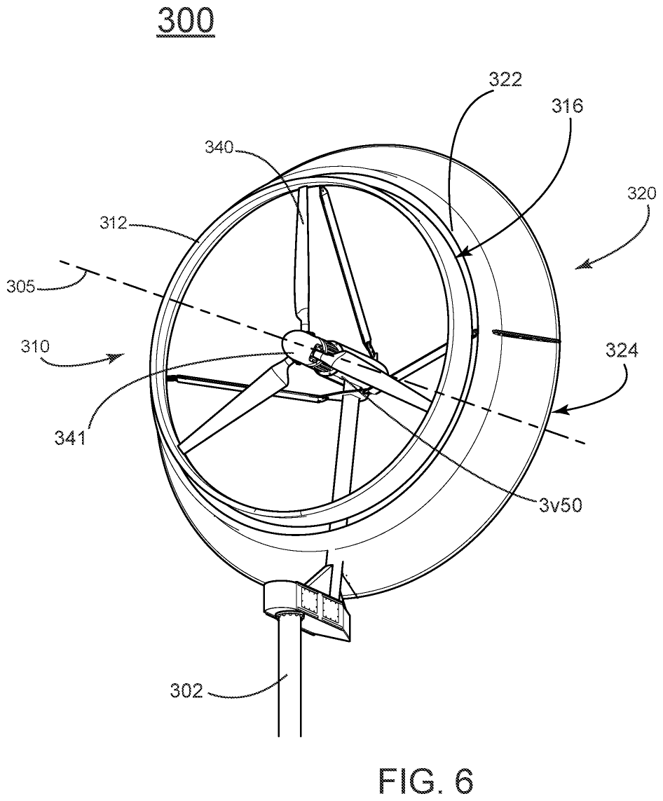

In FIG. 6 an embodiment fluid turbine 300 comprises rotor blades 340 that are joined at a central hub 341 and rotate about a central axis 305. The hub is joined to a shaft that is coaxial with the hub and with the nacelle 350. An annular duct 310 is in fluid communication with the rotor 340. The annular duct or turbine shroud 310 comprises a leading edge portion or inlet 312 that is substantially annular, providing a relatively narrow gap between the rotor blade 340 tips and the interior surface of the leading edge 312. The turbine shroud further comprises a trailing edge or exit 316 of the annular duct 310. The annular duct 310 is coaxial with the rotor 340, rotor hub 341 and nacelle 350 about the central axis 305. A secondary shroud surrounds the exit 316 of the turbine shroud 310 and is referred to as an ejector shroud 320. The ejector 320 has a leading edge 322 and a trailing edge 324. Struts 333 are engaged with the nacelle 350 at the distal end and with turbine shroud 310 at the proximal end. Support members 306 are engaged with turbine shroud 310 and ejector shroud 320. A tower structure 302 supports turbine 300.

1. A method for operating a fluid turbine, the method comprising:
providing a fluid turbine; and
setting power production equal to:
P=V×I×cos cos phi; and
deriving a maximum current output, an actual current output and a current reserve according to:
Iₘₐₓ−I_{actual}; and
adjusting said cos phi to between 0.9 and 1; wherein
the difference between said maximum current output and said actual current output is a reserve current; and said fluid turbine may produce power at a rate greater than said turbine's rated power, without exceeding the maximum current to a power grid.

2. A method for operating a fluid turbine, the method comprising:
providing a fluid turbine; and
setting power production equal to;
P=V×I×\sqrt{3}cos cos phi; and
deriving a maximum current output, an actual current output and a current reserve according to:
Iₘₐₓ−I_{actual}; and
adjusting said cos phi to between 0.9 and 1; wherein
the difference between said maximum current output and said actual current output is a reserve current; and said fluid turbine may produce power at a rate greater than said turbine's rated power, without exceeding the maximum current to a power grid.

3. A method for increasing power production of a fluid turbine without exceeding system maximum load, the method comprising:
providing a fluid turbine; and
adjusting operating cos phi to between 0.9 and 1; and
increasing power production above a rated capacity for said fluid turbine; wherein
said power production may be increased above said rated capacity while maintaining said maximum load within a normal operating range.

4. The method of claim 3 further comprising:
operating said provided fluid turbine at a grid voltage at 600V−10%.
